(19) United States
(12) Patent Application Publication
(10) Pub. No.: US 2024/0303564 A1
(43) Pub. Date: Sep. 12, 2024

(54) GENERATION OF ENTITY PLANS COMPRISING GOALS AND NODES

(71) Applicant: Iterate Studio, Inc., Highlands Ranch, CO (US)

(72) Inventors: Jon Nordmark, Littleton, CO (US); Brainerd Sathianathan, Littleton, CO (US); David Jenkins, Littleton, CO (US); Solomon Ray, Littleton, CO (US); Marek Suscak, Littleton, CO (US); David Rowley, Littleton, CO (US)

(21) Appl. No.: 18/599,017

(22) Filed: Mar. 7, 2024

Related U.S. Application Data
(60) Provisional application No. 63/489,137, filed on Mar. 8, 2023.

(51) Int. Cl. G06Q 10/0631

(52) U.S. Cl. CPC G06Q 10/06313

(57) ABSTRACT

Systems and methods for generating plans are disclosed, where each plan includes actions to achieve goals. An indication to add a goal is received, and a track is displayed representing the goal. For the goal, data describing the goal is received. An input is received to add a node to the track, the node representing an action or area of interest associated with the goal. Within the track, an indication of the node is displayed. One or more node characteristics can be determined and displayed. Additionally or alternatively, a resource may be associated with the node. Using the goal, the data describing the goal, the node, the node characteristics, and/or the resources, the plan is generated. The plan can be output, such as by displaying the plan in a graphical user interface.

### CROSS REFERENCE TO RELATED APPLICATIONS

This application claims priority to U.S. Provisional Application No. 63/489,137 titled “GENERATION OF ENTITY PLANS COMPRISING GOALS AND NODES” filed on Mar. 8, 2023, all of which is incorporated by reference for all purposes herein.

### FIELD

The present disclosure relates generally to systems and methods to generate plans for entities. For example, embodiments described herein can be used to generate a technology plan for an entity to adopt or develop one or more technologies that may involve an ecosystem of interconnected technologies.

### BACKGROUND

Businesses and other entities often adopt, develop, and/or use various technologies to achieve goals or plans. For example, businesses can adopt technologies based on a plan designed to achieve defined goals using specific technology solutions. Examples of such defined goals include improving customer experience, improving inventory control, launching a new product or service, evaluating existing products or services, and so forth. Existing systems for generating these and other plans may be deficient. For example, even when sophisticated technologies are adopted, planning for the adoption of technologies (e.g., technology roadmapping) is typically performed manually, such as by human beings who manually identify specific technologies to achieve goals and organize the technologies using a slide deck or other static document.

Additionally, existing systems may require plans to be updated manually, which can be especially difficult when dealing with rapidly developing technologies or plans that may quickly become obsolete (e.g., within weeks or months). Furthermore, existing systems can be decentralized, such that multiple plans may exist for the same business, and these multiple plans can overlap in scope (e.g., technological scope). Using these decentralized systems, different stakeholders may not even be aware of similar or related work that is performed or planned in other parts of an organization. Thus, existing systems can result in adoption and/or development of redundant nodes and/or technologies (e.g., because plans cannot be centrally accessed and/or cross referenced). For example, the same goal may exist in multiple plans of an entity, but each respective plan might address the goal in a different way (e.g., using a different and/or duplicative technology). Lastly, existing systems typically provide lightweight plans, such as plans that describe only one way to build a technology solution and not, for example, recommendations or options related to solution providers or technical opportunities.

### SUMMARY

Disclosed herein are systems and related methods to generate plans for an entity based on a set of goals and/or using one or more nodes (“system” or “plan generation system”). As used herein, a “plan” can be a set of goals, actions, and/or nodes associated with an entity.

In one embodiment, a computer-implemented method for presenting a plan includes displaying, in a user interface, a track that represents a goal, and displaying, in the user interface and within the track, a node that represents a desired action or an area of interest associated with the track. A status of the node is displayed in the user interface with the node. A resource associated with the node is displayed in the user interface with the node.

In another embodiment, a system includes a processing element and a memory. The memory stores instructions, that when executed by the processing element, cause operations to be performed. The operations include receiving, via a first user interface, an indication to add a goal to a plan and data describing the plan. A track that represents the goal is displayed in a second user interface. An indication to add a node to the track is received via the second user interface. The node represents a desired action or an area of interest associated with the goal. Data describing the node is received via a third user interface. The node is displayed in the second user interface and within the track. One or more icons are displayed in the second user interface within the node. The one or more icons can represent at least one of a status of the node, a resource is associated with the node, or a category is associated with the node.

In yet another embodiment, a method includes receiving an indication to add a goal to a plan and data describing the goal. The data describing the goal is associated with a track. An indication to add a node within the track is received. The node represents a desired action or an area of interest associated with the goal. Data describing the node is received. The plan is generated based on the goal, the data describing the plan, and the data describing the node. The plan is output, such as by displaying the plan in a graphical user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present technology as defined in the claims is provided in the following written description of various embodiments and implementations and illustrated in the accompanying drawings.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 is a block diagram illustrating an environment in which a plan generation system operates, in some implementations;

FIG. 2 is a block diagram illustrating a computing device that can be used to implement a plan generation system, in some implementations;

FIG. 3 illustrates a display screen displaying an example graphical user interface (GUI) generated by a plan generation system, in some implementations;

FIG. 4 illustrates a display screen displaying an example GUI generated by a plan generation system, in some implementations;

FIG. 5 illustrates a display screen displaying an example GUI generated by a plan generation system, in some implementations;

FIG. 6 is a flow diagram illustrating a process to generate a plan based on a set of goals, in some implementations;

FIG. 7 is a flow diagram illustrating a process to generate a plan based on a set of goals, in some implementations;

FIG. 8 is a flow diagram illustrating a process to generate recommendations, in some implementations;

FIG. 9 is a flow diagram illustrating a process train a machine learning module to generate recommendations, in some implementations;

FIG. 10 is a block diagram illustrating components associated with a plan, in some implementations; and

FIG. 11 is a block diagram illustrating a platform architecture, in some implementations.

### DETAILED DESCRIPTION

Businesses typically generate plans for various purposes, such as for forecasting future technology needs, scouting to identify suitable emerging technologies for one or more goals, evaluating new/emerging technologies in relation to goals, meeting business and/or technical goals, improving technical and/or business performance, partnering with other entities in relation to goals, and so forth. For example, a plan can be used to help a business or other entity identify existing technologies that can be used to achieve a goal and/or new technologies that need to be acquired or developed to achieve a goal. Existing planning systems typically require that the business or other entity manually identify such technologies and manually identify interconnected data relationships between or related to such technologies for inclusion in a static plan. Additionally or alternatively, a plan can help a business identify other businesses with technological capabilities that can help to achieve one or more goals. For example, a large business may wish to identify and use technologies provided by one or more startup companies.

Disclosed herein are systems and related methods to generate plans for an entity based on a set of goals and/or using one or more nodes (“system” or “plan generation system”). As used herein, a “plan” can be a set of goals, actions, and/or nodes associated with an entity. A plan can take various forms, such as a graphical representation in a grid or graph format, as described herein. Additionally or alternatively, a plan can be represented or stored as a table, spreadsheet, or delimited file. In some implementations, a plan can comprise a set of tables in a relational database, such as a set of tables having defined relationships among themselves. In some implementations, a plan can be a technology road map for one or more technologies to be adopted and/or developed by the entity, such as technologies to achieve goals in the set of goals and/or perform identified actions. For example, a technology road map can comprise a set of technologies that, when adopted or developed by a business, improve customer experience of using a mobile application of the business.

According to an embodiment, a plan may include a set of tracks, each track comprising one or more nodes. The nodes can include one or more point solutions, such as technologies that can be used to implement the node. For instance, a plan associated with a digital customer relationship management system can include tracks and/or nodes for specific software functionalities within a given existing internal application as well as other tracks and/or nodes that require external connections to applications. In some implementations, nodes can be associated with a set or collection of technologies, which can be ranked, graded, or rated. Ranking, grading, rating, and/or other data provided about technologies associated with nodes can provide transparency regarding the ways in which a solution can be produced, and this data can facilitate decision making in relation to the technologies. Tracks can be sortable within respective plans, and nodes can be sortable within respective tracks. Nodes can have one or more properties or characteristics and/or related entities. For example, nodes can have an assigned status (e.g., “in flight,” “planning,” “not started”) and/or a category, which can be used to filter, sort, and/or rank the nodes. Properties and/or characteristics associated with nodes can have one or more visual cues, such as custom colors and/or shapes to represent corresponding statuses or categories.

In some implementations, each entity (e.g., plan, track, node) and its corresponding qualities or properties can be stored in a relational database, with each entity having a separate database entry. The relational database can record relationships between the entities (e.g., relationships between plans, tracks, and nodes).

In some implementations, the disclosed system includes an automatic suggestion engine to generate recommendations of tracks to include in a plan and/or nodes to include in a track. In some implementations, the automatic suggestion engine comprises and/or uses one or more artificial intelligence or machine learning models or algorithms to generation recommendations. For example, the disclosed system can train one or more machine learning models using a dataset of existing plans that are contextually similar in content and have similar nodes. The one or more models can be trained on an ongoing basis, such as through reinforced learning or ensemble learning. In some implementations, the models can include neural networks or other models to automatically generate suggested solutions to be placed within each node. In some implementations, tracks, nodes, and/or plans can contain or be associated with textual, graphical, and/or relational structures that are generated via machine learning models. For example, the disclosed technology can include a model or algorithm trained or configured to generate relational structures to define links between objects (e.g., plans, tracks, nodes, data, objects) and/or generate recommendations based on relational structures.

In some implementations, a plan comprises a set of goals, such as business and/or technical goals of the entity, which can each be represented as a track. Examples of business goals include launching a new business offering, evaluating a customer experience, increasing revenue, tracking inventory, and so forth. Examples of technical goals include launching an application or website, improving existing technologies (e.g., improving speed of a website or application), monitoring or evaluating user interactions with entity technologies, adopting or developing a new technology, and so forth. Each goal in the set of goals can be associated with a goal statement and/or one or more other goal characteristics. Additionally, each goal can be associated with one or more nodes. A node can represent, for example, an action and/or an area of interest within each goal. For example, for a goal of evaluating customer experience (e.g., related to a website), corresponding nodes can include monitoring website speed, tracking user engagement or interactions, generating content for a website, and so forth. Additionally, each node can be associated with one or more characteristics, such as characteristics of a corresponding action or area of interest. Examples of node characteristics include status information, category information, a node description, and/or a resource. A resource associated with a node can be a technological resource and/or an entity, such as a resource relevant to an action and/or an area of interest for the node. For example, the node can represent an action in furtherance of a corresponding goal, while a resource can specify one or more technologies and/or one or more providers of technologies capable of performing the action. A node for monitoring website speed, for example, can be associated with a description (e.g., “monitor speed of ordering website to gauge customer experience and satisfaction”), status information (e.g., planned, in development, or implemented), category information (e.g., retail operations or online services), and one or more resources (e.g., startup companies, available technologies for speed monitoring, or URLs corresponding to the same).

In some implementations, the plan generation system provides one or more improved user interfaces, such as GUIs, for generating, viewing, and interacting with plans. For example, a user interface (e.g., a GUI) provided by the plan generation system can provide a flexible or configurable graph or grid structure to visualize the plan and goals/tracks and/or nodes included in the plan. The GUI can indicate characteristics of each node, such as status information, category information, and/or resource information. Thus, the GUI can facilitate analysis of plans, such as by providing a fast and easy way to check the current characteristics of the plan, the goals/tracks, and/or the nodes. Additionally, GUI can be used to generate, view, and/or modify plans. In these and other implementations, the GUI can provide a central portal for accessing a plan and all related goals/tracks, nodes, and/or characteristics. For example, the GUI can help to integrate the plan with one or more other systems in a way that is not possible using existing systems. Other systems may, for example, provide additional information about technologies and/or entities which may be included in various plans. For example, the GUI can directly associate nodes to resources using URLs, such as URLs to facilitate implementation of the plan and/or URLs associated with other systems. In some examples, a linked system may manage, rank, score, or index entities (e.g., entities providing technologies identified in a plan), as disclosed in U.S. Pat. No. 11,341,517, titled “INDEXING ENTITIES BASED ON PERFORMANCE METRICS,” which is incorporated by reference as if fully set forth herein.

Advantages of the disclosed technology include providing improved systems and methods for generating plans, such as systems and methods having improved GUIs for graphically generating and configuring plans. Additionally, the disclosed technology can unite multiple systems for use in a single plan. And the disclosed technology can be used to conserve resources, such as technical resources. For example, the disclosed technology can be used to identify existing resources for inclusion in a plan, thus avoiding acquisition and/or creation of duplicative or redundant resources when an existing resource can be associated with a node and/or a goal/track. Furthermore, the disclosed technology can quickly and dynamically identify goals, tracks, nodes, or resources for inclusion in a plan, such as technologies or other resources to be acquired or developed.

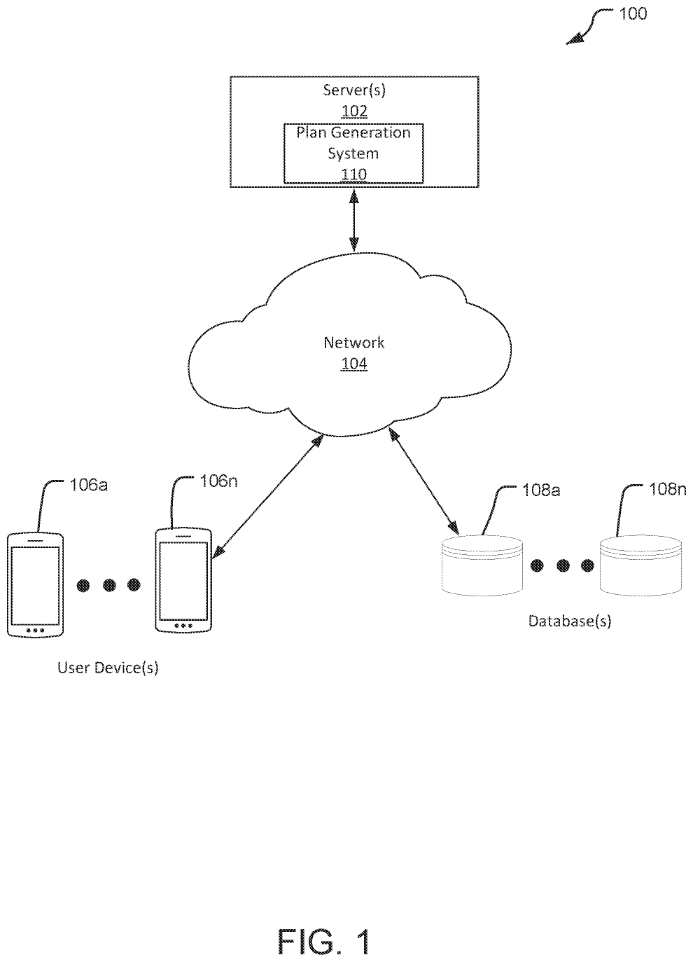

Turning now to the figures, a system of the present disclosure will be discussed in more detail. FIG. 1 is a block diagram illustrating an environment 100 in which a plan generation system (e.g., plan generation system 110) operates, in some implementations. The environment 100 includes one or more user devices 106a-n and one or more databases 108a-n. The environment 100 can also include one or more servers 102, which can be in communication with the user device(s) 106a-n and database(s) 108a-n. In some implementations, the plan generation system 110 resides, at least in part on the server(s) 102, although at least a portion of the plan generation system 110 can also reside elsewhere (e.g., in one or more user device(s) 106a-n). For example, a user of a user device 106a-n can access the plan generation system 110 via the network 104 to generate, access, or modify various plans. The user can be an employee of a business, and the plans can relate to business or technical goals of the business, such as technology road maps for developing or adopting technologies for the business. The user can provide inputs via the user device 106a-n to generate or modify a plan, search for or view existing plans, and so forth. The plans can be stored in one or more of databases 108a-n, which can be accessed by the plan generation system 110. The databases 108a-n can include relational databases comprising plans, tracks, nodes, and associated data as well as relationships between plans, tracks, nodes, and associated data. A relational database can include links or relations between objects, which can comprise a set of tuples having the same attributes. A tuple can represent an object and information about that object. Objects can be physical objects or concepts, such as plans, tracks, goals, nodes, and/or associate data. A relation can be described or represented as a table, which is organized into rows and columns. All the data referenced by an attribute are in the same domain and conform to the same constraints. A relational model can specify that the tuples of a relation have no specific order and that the tuples, in turn, impose no order on the attributes. In some implementations, a relational database can include a detail page for each object represented in the system (e.g., data, nodes, tracks, plans, businesses or organizations), which allows the object to be linked to various other objects. The links can be text used to define the relationships for the relational database, such as text received from a user or generated automatically (e.g., using a suggestion engine and/or an autocomplete feature). The relational database can define links between objects or data sets in the database, such as solutions, trends, entities, and so forth. When generating plans, tracks, or nodes, the system can conduct a matching assessment (e.g., using a matching algorithm) to identify objects in one or more databases based on characteristics defined in the object profiles. For example, the system can compare a new plan, track, or node with existing objects in one or more relational databases using a matching algorithm and recommend existing plans, tracks, or nodes when a match is determined (e.g., based on a matching score exceeding a threshold score).

The plan generation system 110 can reside on one or more of server(s) 102, such as a web server. In some implementations, the plan generation system 110 can be implemented, at least in part, as a cloud-based system, such as using the one or more server(s) 102. The various components in the environment 100 can be in communication directly or indirectly with one another, such as through a network 104. In this manner, each of the components can transmit and receive data from other components in the environment 100. For example, the server(s) 102 can be in communication with the user device(s) 106a-n and the database(s) 108a-n over the network 104. In many instances, the server(s) 102 can act as a go between for components in the environment 100.

The network 104 can be substantially any type or combination of types of communication system for transmitting data either through wired or wireless mechanisms (e.g., cloud, WI-FI®, Ethernet, BLUETOOTH®, cellular data, or the like). In some embodiments, certain components in the environment 100 can communicate via a first mode (e.g., BLUETOOTH®) and others can communicate via a second mode (e.g., WI-FI®). Additionally, certain components can have multiple transmission mechanisms and be configured to communicate data in two or more manners. The configuration of the network 104 and communication mechanisms for each of the components can be varied as desired.

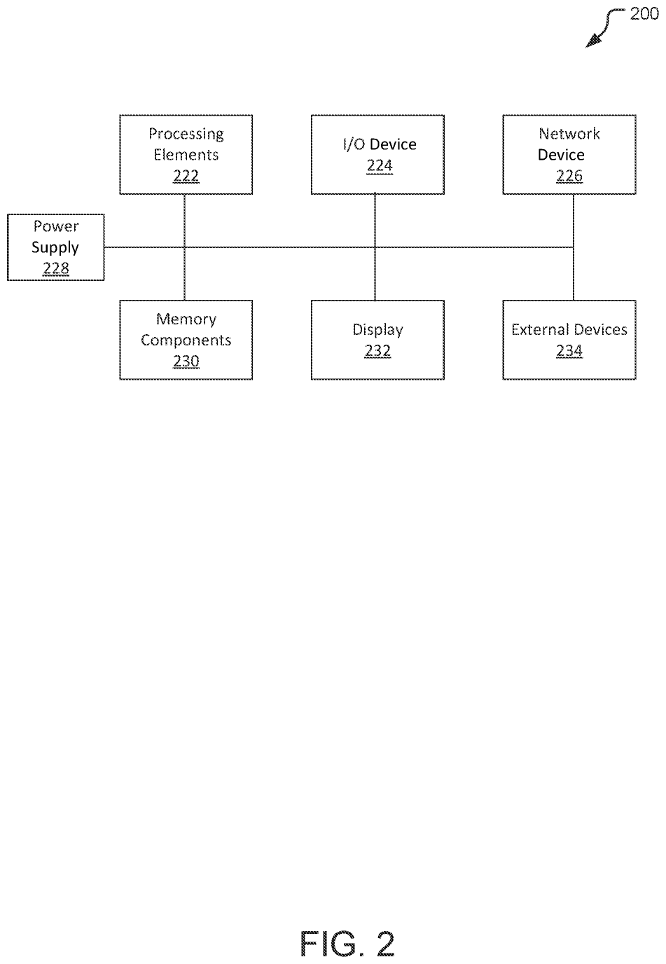

The server(s) 102 includes one or more computing devices that process and execute information. The server(s) 102 can include its own processing elements, memory components, and the like, and/or can be in communication with one or more external components (e.g., separate memory storage) (an example of computing nodes that can be included in the server(s) 102 is disclosed below with respect to FIG. 2). The server(s) 102 can also include one or more server computers that are interconnected together via the network 104 or separate communication protocol. The server(s) 102 can host and execute a number of the processes executed by the plan generation system 110 (e.g., processes for generating plans, instructions for generating GUIs).

The server(s) 102 has or offers a number of configurable application programming interfaces (API) that can be accessed and used from an application on a user device 106a-n to send and receive data to the server(s) 102. To prevent unauthorized access, applications can be required to authenticate sessions or connections via a license key or other code.

The user device(s) 106a-n can be any of various types of computing devices, e.g., smart phones, tablet computers, desktop computers, laptop computers, set top boxes, gaming devices, wearable devices, or the like. The user device(s) 106a-n provides output to and receives input from a user. For example, the user device(s) 106a-n can receive inputs associated with plans generated by the system (e.g., plan information, goal information, node information), and the user device(s) 106a-n can output one or more displays, such as displays including GUIs (e.g., graphical representations of plans). The type and number of user devices 106a-n can vary as desired.

The database(s) 108a-n store data that can be used by the server(s) 102 to generate, modify, and/or access plans. The databases can be stored on the server(s) 102 and/or can be separate structures accessible by the server(s) 102 as needed. The databases 108a-n can store various data associated with plans, such as representations of plans, goals/tracks, nodes, node characteristics, status information, category information, resource information, and/or information for entities associated with plans. As another example, third party databases can be accessed, for example, that contain public or other accessible information related to plans. In many instances, the system can include a combination of managed and third-party databases.

FIG. 2 is a block diagram illustrating a computing device 200 that can be used to implement a plan generation system (e.g., plan generation system 110 of FIG. 1), in some implementations. The computing device 200 can be, for example, one or more server(s) 102 and/or one or more user devices 106a-n, as illustrated in FIG. 1, and/or the computing device 200 can host and/or access one or more databases 108a-n. In these and other implementations, the computing device 200 can be used to implement a plan generation system, such as the plan generation system 110 of FIG. 1.

With reference to FIG. 2, the computing device 200 can include components comprising a processing clement 222, an input/output (I/O) device 224, a network device 226, a power supply 228, a memory component 230, a display 232, and/or an external device 234. Each of the components can be in communication with one another through one or more busses, wireless means, or the like. Although FIG. 2 depicts one of the processing element 222, the I/O device 224, the network device 226, the power supply 228, the memory component 230, the display 232, and the external device 234, other implementations can include one or more processing elements 222, one or more I/O devices 224, one or more network devices 226, one or more power supplies 228, one or more memory components 230, one or more displays 232, and/or one or more external devices 234.

The processing element 222 can be any type of electronic device capable of processing, receiving, and/or transmitting instructions and data. For example, the processing element 222 can be a central processing unit, microprocessor, processor, microcontroller, graphical processing unit, and/or a combination of multiple processing elements. For example, a first processing element can control a first set of components of the computing device and a second processing element can control a second set of computing devices, where the first processing element and the second processing element may or may not be in communication with one another. Additionally, the processing clement 222 can be configured to execute one or more instructions in parallel and across the network, such as through cloud computing resources.

The I/O device 224 receives and transmits data to and from the network 104. The I/O device 224 allows a user to enter data into the computing device 200, as well as provides an input/output for the computing device 200 to communicate with other devices (e.g., server(s) 102, other computers, speakers, etc.). The I/O device 224 can include one or more input buttons, touch pads, and so on. For example, the computing device 200 can receive inputs via the I/O device 224 related to generation of a plan (e.g., plan information, goal/track information, node information), and I/O device 224 can be used to provide outputs of the system, such as graphical representations of plans.

The network device 226 provides communication to and from the computing device 200 to other devices. For example, the network device 226 allows the server(s) 102 to communicate with the user device(s) 106a-n through the network 104. The network device 226 can use one or more communication protocols, such as, but not limited to WI_FI®, Ethernet, BLUETOOTH®, and so on. The network device 226 can also include one or more hardwired components, such as a Universal Serial Bus (USB) cable, or the like. The configuration of the network device 226 depends on the types of communication desired and can be modified to communicate via WI-FI®, BLUETOOTH®, and so on.

The power supply 228 provides power to various components of the computing device 200. The power supply 228 can include one or more rechargeable, disposable, or hardwire sources, e.g., batteries, power cords, or the like. Additionally, the power supply 228 can include one or more types of connectors or components that provide different types of power to the computing device 200. In some embodiments, the power supply 228 can include a connector (such as a universal serial bus) that provides power to the computing device 200 or batteries within the computing device 200 and also transmits data to and from the device to other devices.

The memory component 230 stores electronic data, such as, for example, plan information, goal/track information, node information, and the like, that can be utilized by the computing device 200. The memory component 230 can include electrical data or content, such as processor instructions (e.g., software code), audio files, video files, document files, and the like. The memory component 230 can include multiple components, such as, but not limited to, non-volatile storage, a magnetic storage medium, optical storage medium, magneto-optical storage medium, read only memory, random access memory, erasable programmable memory, flash memory, or a combination of one or more types of memory components. In many embodiments, the server(s) 102 can have a larger memory capacity than the user devices 106a-n.

The display 232 provides visual feedback to a user and, optionally, can act as an input node to enable a user to control, manipulate, and calibrate various components of the computing device 200. The display 232 can be a liquid crystal display, plasma display, organic light-emitting diode display, and/or cathode ray tube display. In embodiments where the display 232 is used as an input, the display 232 can include one or more touch or input sensors, such as capacitive touch sensors, resistive grid, or the like, such that the display screen of the display 232 functions as a touchscreen.

The external device 234 can be one or more devices that can be used to provide various inputs to, or outputs from, the computing device 200. Non-limiting nonexclusive examples of the external device include a mouse, a microphone, a keyboard, a trackpad, a speaker, a printer, an external storage device, or the like. The external device 234 can be local or remote and can vary as desired.

It should be noted that the computing device 200 can be in communication with a compute back end, such as the server(s) 102 or a cloud provider, e.g., Google Cloud Platform, Amazon Web Services, Microsoft Azure, or the like.

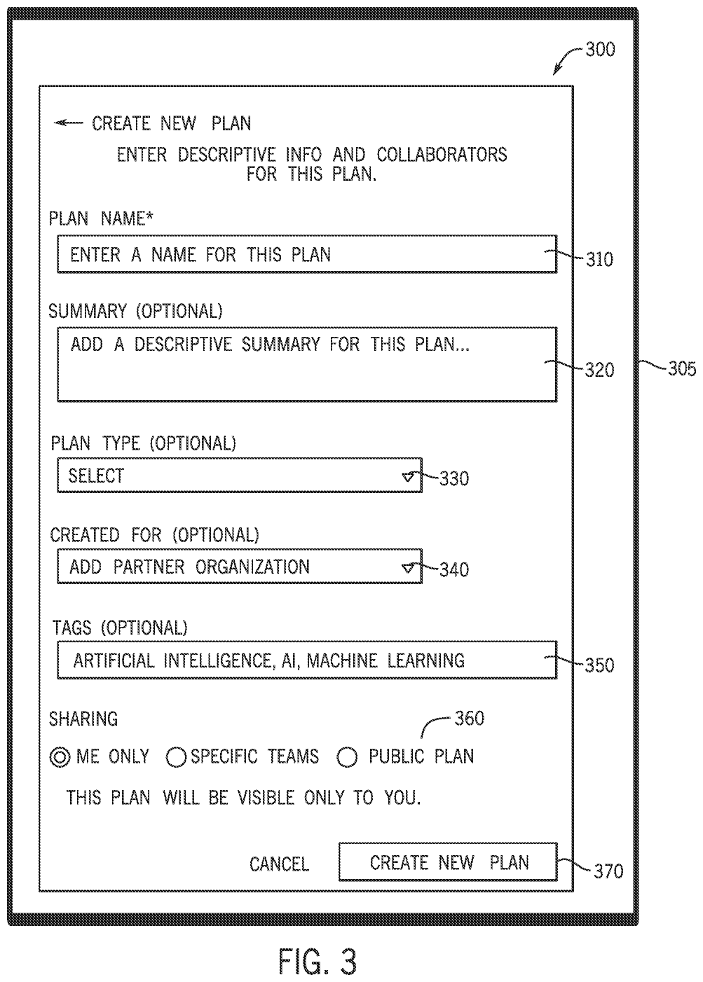

FIG. 3 illustrates a display screen 305 displaying an example GUI 300 generated by a plan generation system (e.g., plan generation system 110 of FIG. 1), in some implementations. For example, the GUI 300 can be provided by the plan generation system to build one or more plans, as described herein. In various examples, the GUI 300 may be displayed at one or more user devices (e.g., user devices 106a-106n) in communication with or accessing the plan generation system 110. Additionally or alternatively, the GUI 300 can be generated by and/or using the computing device 200 of FIG. 2.

To generate a new plan, the plan generation system can receive a selection of a button or icon (not shown) to generate a new plan, which causes the GUI 300 to be displayed on the display screen 305 of a display (e.g., display 232 in FIG. 2). Such a selection may be received from a user device (e.g., any of user devices 106a-106n) in communication with the plan generation system 110. The plan generation system receives various inputs via the GUI 300 related to the plan.

The GUI 300 can include a plan identifier field 310, via which an identifier is received for the plan (e.g., a name and/or an identifying number). The plan identifier field 310 can be configured to receive inputs comprising, for example, character strings.

The GUI 300 can also include a plan summary field 320, via which a descriptive summary for the plan is optionally received. The plan summary field 320 can also be configured to receive, for example, character strings and/or other text.

The GUI 300 can also include a plan type field 330, via which a plan type is optionally received. The plan type field 330 can be, for example, a dropdown menu that, when selected, displays one or more selectable indications (not shown) of predetermined plan types. Examples of plan types include a strategy type or an execution type. For example, a strategy type can indicate that the plan relates to determining and/or pursuing one or more strategies for an entity (e.g., a technology strategy), while an execution type can indicate that the plan relates to executing one or more actions (e.g., technology actions), such as by planning and/or executing actions in furtherance of one or more goals.

Any number of plan types can be created. Examples of plans include: (1) A plan related to a new software application to be developed, where each track represents a customer interaction, and each node represents a specific functionality that draws from internally developed resources or outsourced third-party code; (2) A plan related to a business strategy for developing a new market, where each track represents a specific phase of development, and each node represents a specific customer interaction, a software application to be deployed, and/or a hardware to be launched; and (3) A plan related to an organization's internal digital transformation efforts, where each track represents an internal department, and each node represents a specific software application to be updated/replaced, an internal resource to be modified, and/or a new data source to be acquired.

The GUI 300 can also include a partner entity field 340, via which a selection of a partner entity is optionally received. The partner entity field 340 can be, for example, a dropdown menu that, when selected, displays one or more selectable indications (not shown) of predetermined partner entities. A partner entity can be, for example, a business or other entity associated with the plan. For example, the plan generation system can be provided and/or used by a first entity that facilitates and/or provides technology planning, while a second entity can be a partner entity of the first entity, and the plan can be a technology plan for the partner entity.

The GUI 300 can also include a tag field 350, via which one or more tags can optionally be received for inclusion in a plan. The tags can indicate, for example, one or more topics or characteristics associated with a plan. For example, tags can indicate technologies or types of technologies included in or associated with the plan.

The GUI 300 can also include a sharing field 360, via which a selection can be received of one or more options for sharing and/or visibility of the plan. For example, an input received via the sharing field 360 can indicate whether the plan will be visible only to a user that generates the plan, to a specific team of users (e.g., users associated with an entity or a team of the entity), and/or to all users of the plan generation system.

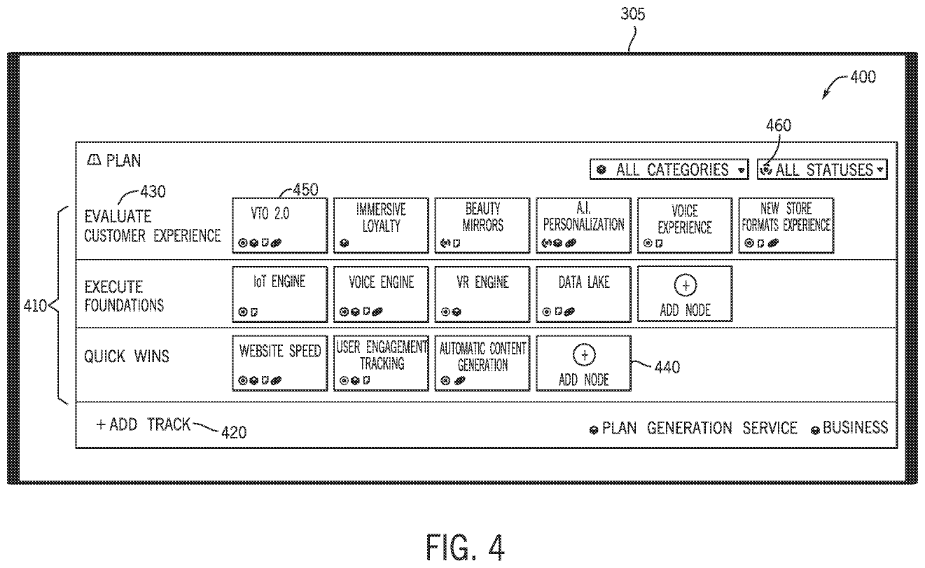

The GUI 300 can also include one or more buttons 370, such as a cancel button, a select button, and/or a create plan button. For example, selection of the cancel button can terminate generation of the plan, while selection of the create plan button can cause display of a different GUI (e.g., the GUI 400 of FIG. 4) to be displayed to continue creating the plan.

Generally speaking, inputs received via the GUI 300 can be used to identify, define, and/or describe a plan, and the inputs can be used to locate, filter, search, and/or sort plans in a set of multiple plans. For example, the plan generation system can provide and/or access a database or other data store of plans, and the inputs can be used to search and/or sort among the set of multiple plans (e.g., based on plan names, descriptions, types, partner entities, owners/users and so forth).

FIG. 4 illustrates a display screen 305 displaying an example GUI 400 generated by a plan generation system (e.g., plan generation system 110 of FIG. 1), in some implementations. For example, the GUI 400 can be provided by the plan generation system to build one or more plans, as described herein. In various examples, the GUI 400 may be displayed on the display screen 305 at one or more user devices (e.g., user devices 106a-106n) in communication with or accessing the plan generation system 110. Additionally or alternatively, the GUI 400 can be generated by and/or using the computing device 200 of FIG. 2.

The GUI 400 can be configured in a graph or grid format comprising one or more tracks 410, each track representing a goal included in the plan. Each track can be a row in the graph or grid. For example, the top-most track of the tracks 410 represents the goal of evaluating a customer experience of customers of a business associated with the plan. The graph or grid format provides a graphical representation of the plan. To add a track (and thus add a goal to the plan), the GUI 400 receives a selection of an add track button 420. In response to receiving the selection of the add track button 420, the plan generation system adds the track to the GUI 400. Additionally, a title and/or a description 430 are received for the track and displayed.

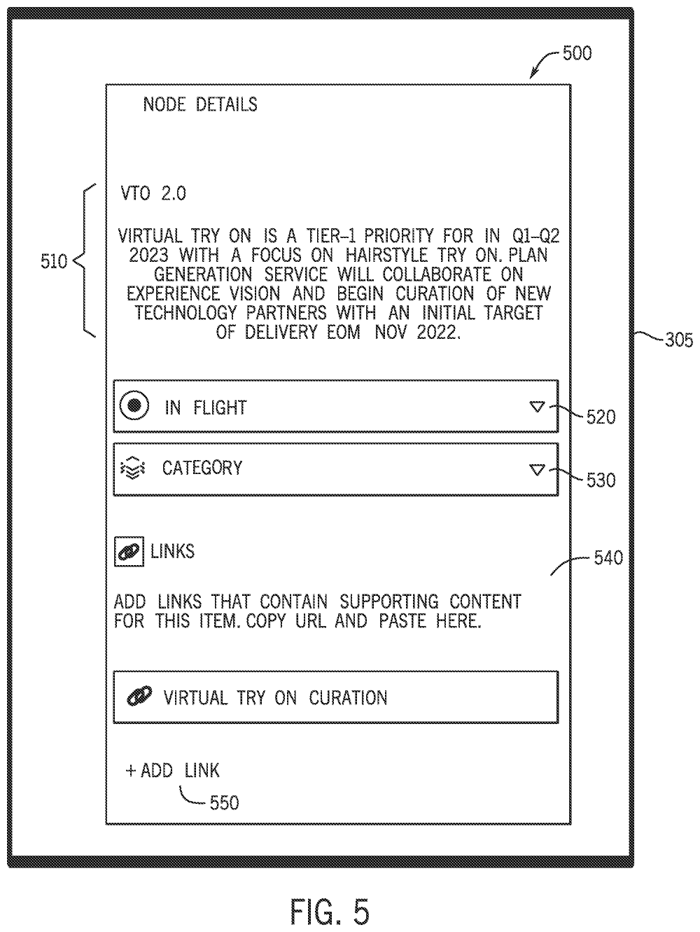

Once the track has been added, nodes 450 can be added to the track in response to receiving a selection of an add node button 440, the nodes representing an action or area of interest associated with a corresponding goal for the track. For example, a node can represent an action of website speed monitoring or user engagement tracking (e.g., engagement with an application or website), or a node can represent an area of interest, such as a product type (e.g., beauty mirrors) or business offering (e.g., a customer loyalty program). Each node 450 includes a title and/or one or more icons indicating characteristics of the node 450. The title can be provided, for example, by clicking on a node 450 and typing the title into a title field (not shown). Node characteristics represented by the icons can include a node category, status, description, and/or resource, which are described in additional detail with reference to FIG. 5. The icons can be color coded and/or can vary in shape to indicate the one or more characteristics. For example, a status icon can be green to indicate that the node 450 is in in progress, red to indicate that the node 450 is not started, or blue to indicate that the node 450 is in the planning stages. A category icon can also be color-coded, for example, to indicate user-defined categories, such as a yellow icon to indicate that a node 450 is associated with a first entity and an orange icon to indicate a node 450 associated with a second entity. The icons can update automatically (e.g., in real time or substantially real time) to reflect changes in status, category, or resources. For example, a color of an icon can change to indicate a change in the status or category, or a resource icon can be displayed only when a corresponding resource is present or accessible. The icons can be selectable or actionable. For example, a resource icon can include a link to a corresponding resource, such as a link to information about entities providing technology or information or implementation details for a technology. Any number of tracks 410 and/or nodes 450 can be added.

The GUI 400 also includes one or more filters 460 to facilitate filtering of data included in a plan. When selected, a filter 460 provides a menu (not shown) with indications of one or more options for filtering nodes 450 displayed in the GUI 400. For example, the filters 460 can be used to filter nodes 450 based on a status and/or a category. A filter may be used, for example, to view nodes 450 of the plan which are in progress. Additionally or alternatively, a filter can be used to view nodes 450 of the plan that are associated with specific categories, such as entities associated with or included in the plan or categories of technical or business operations of an entity associated with the plan.

The graph or grid view provided by the GUI 400 can be configured in various ways. For example, the nodes 450 can be uniform in shape (e.g., rectangles having the same dimensions), and a track comprising nodes 450 can be configured to scroll left or right, such that only a predetermined number of nodes (e.g., six nodes) is visible when the track becomes wider than the GUI 400. In some implementations, the number of nodes 450 visible in a track can be based on a width of a display on which the GUI 400 is showing. Additionally or alternatively, the nodes 450 can vary in size and/or shape. For example, the nodes 450 can be rectangular, and a size of the nodes 450 can change to accommodate a greater number of nodes 450 being displayed in the GUI 400. The nodes 450 can have a first length and width when six or fewer nodes 450 are included in a row, and the nodes 450 can be modified to have a second length and width when a seventh node 450 is added (e.g., because seven nodes with the first length and width would not fit within the GUI 400). For instance, the second height can be smaller than the first height (e.g., half of the first height), such that the height of the nodes 450 is reduced to accommodate a display of seven or more nodes (e.g., with at least some nodes 450 appearing in stacked pairs in each track). Generally speaking , display of the nodes 450 can vary to accommodate various views that scroll (e.g., vertically and/or horizontally) and/or reconfigure (e.g., changing width and/or height of nodes 450) to change the number of nodes 450 that are visible.

FIG. 5 illustrates a display screen 305 displaying an example GUI 500 generated by a plan generation system (e.g., plan generation system 110 of FIG. 1), in some implementations. For example, the GUI 500 can be provided by the plan generation system to configure a node within a plan, such as a node 450 of FIG. 4. In various examples, the GUI 500 may be displayed on the display screen 305 at one or more user devices (e.g., user devices 106a-106n) in communication with or accessing the plan generation system 110.

The GUI 500 comprises a detail view for a node. The features described with reference to the GUI 500 generally relate to characteristics of a node. Based on these characteristics, display of the node (e.g., as shown in FIG. 4) can change. For example, the display of nodes can include various icons having specific shapes and/or colors to indicate characteristics, such as status, category, and/or presence or absence of resources.

In response to receiving a selection of a node (e.g., node 450 of FIG. 4), the GUI 500 is displayed on the display screen 305 (e.g., a display screen at a user device of the user devices 106a-106n). The GUI 500 includes a node information region 510, which displays a node title and a node description. For example, the node description can describe one or more actions or areas of interest for the node. The node description can be provided by clicking within the node information region 510 and typing the node description.

The GUI 500 also includes a status information field 520 to indicate a status of a node. When selected, the status information field 520 can provide a menu (not shown) of predetermined node statuses. Examples of node statuses include “in flight” (e.g., an action is being undertaken for the node), “planning” (e.g., one or more actions are being planned for the node but have not yet been executed), “not started” (e.g., no actions taken or planned yet), and/or “no status” (e.g., status information is not available for the node). Each status can be associated with a color-coded icon that is displayed in the node.

The GUI 500 also includes a category field 530. When the category field 530 is selected, a prompt or GUI (not shown) can be displayed for providing a user-generated category. Thus, a user can provide a name for the category and select a color for a category icon to be displayed in the corresponding node.

The GUI 500 also includes a resource region 540, where an indication of a resource can be received. For example, a user can select an add link button 550 and add a resource to the node, such as by providing a uniform resource locator (URL) for the resource.

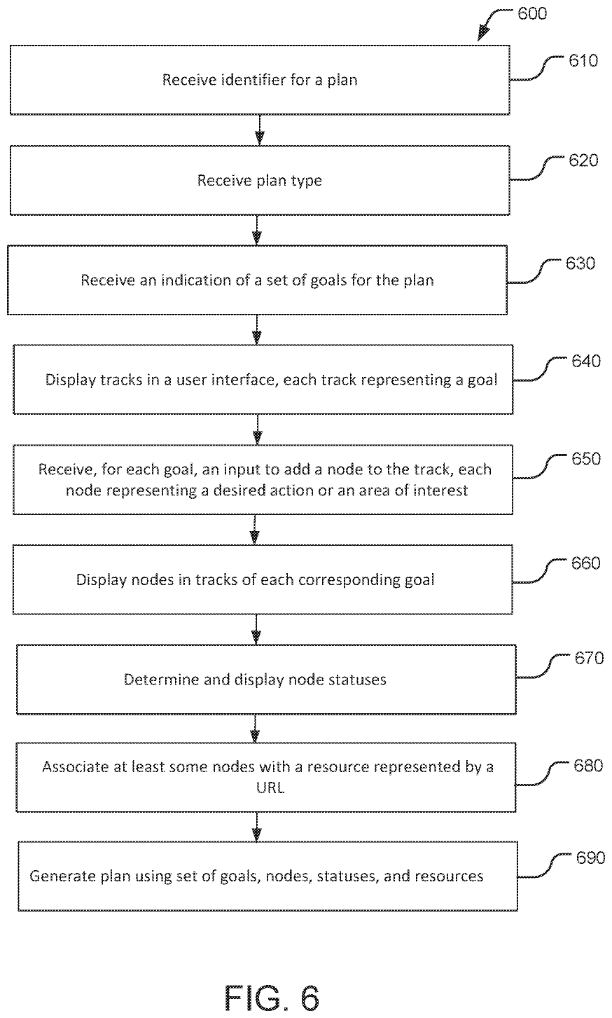

FIG. 6 is a flow diagram illustrating a process 600 performed by plan generation system (e.g., plan generation system 110 of FIG. 1) to generate a plan based on a set of goals, in some implementations. The process 600 can be performed, for example, using the computing device 200 of FIG. 2. Additionally, the process 600 can be performed using one or more of GUIs 300 of FIG. 3, 400 of FIG. 4, or 500 of FIG. 5.

The process 600 begins at block 610, where an identifier is received for a plan. The identifier can be a name, a title, an identifying number, or the like. The identifier can be received, for example, by a processor and from a user (e.g., as a typed input). The identifier can be received via a GUI (e.g., the GUI 300) presented at a user device (e.g., of user devices 106a-106n).

The process 600 proceeds to block 620, where a plan type is received for the plan. The plan type can be, for example, a strategy type or an execution type. A strategy type can indicate that the plan relates to a business or technical strategy, such as a strategy for increasing customer engagement, improving customer experience, or improving website performance. An execution type can indicate that the plan relates to execution of one or more defined actions, such as implementation of a new technology or launching a new product or service. The plan type can be received, for example, as a selection from a dropdown menu or as a typed input. The plan type can be received via a GUI (e.g., the GUI 300) presented at a user device (e.g., of user devices 106a-106n).

The process 600 proceeds to block 630, where an indication is received of a set of goals to include in the plan. For example, each goal can be received from a user when the user selects an option (e.g., an icon) to add a goal to a plan, and the user can provide goal information including a title and/or a description for the goal. The set of goals can be received via a GUI (e.g., the GUI 400) presented at a user device (e.g., of user devices 106a-106n).

The process 600 proceeds to block 640, where tracks are displayed, each track corresponding to a goal in the set of goals. Examples of goals include evaluating customer experience or executing specific technologies or groups of technologies. The tracks can be displayed in a GUI (e.g., the GUI 400) at a user device (e.g., of user devices 106a-106n).

The process 600 proceeds to block 650, where one or more inputs are received for each goal, the one or more inputs being to add a node to a corresponding track. As described herein each node can represent an action and/or an area of interest associated with a corresponding goal. Examples of actions or areas of interest include monitoring a website speed, tracking user engagement or interactions, or specific product or service offerings (e.g., a customer loyalty program or a virtual product try-on feature). A node can be added, for example, when a user selects an option (e.g., an icon) to add a node to a goal. The inputs can be received via a GUI (e.g., the GUI 400) presented at a user device (e.g., of user devices 106a-106n).

The process 600 proceeds to block 660, where nodes are displayed in response to the inputs received at block 650. As described herein, the nodes can be displayed as rectangles or other shapes, and the nodes can be arranged in a graph or grid format. The nodes can have a uniform size and/or shape, or the nodes can vary in shape or dimensions (e.g., to fit within a GUI). The nodes can be displayed in a GUI (e.g., the GUI 400) presented at a user device (e.g., of user devices 106a-106n).

The process 600 proceeds to block 670, where a status is determined for at least some of the nodes displayed at block 660. In some implementations, the status can be determined based on a user input. For example, a user can indicate a status for a node by selecting the status from a dropdown menu of a GUI (e.g., GUI 400 or GUI 500) displayed on a user device (e.g., of user devices 106a-n). In some implementations, the status can be determined automatically (e.g., by querying a database, performing one or more processor-implemented instructions, or the like). For example, the plan generation system can query a database of implemented technologies to determine an operational or developmental status of a technology associated with a node. Additionally or alternatively, the plan generation system can track availability of technologies that will be implemented in relation to a node. In some implementations, a node can depend on another node, such that a status of the node depends on the status of the other node. For example, implementation of a first node may be a condition precedent to implementation of a second node. Therefore, the plan generation system can determine whether the first node has been implemented to determine whether implementation of the second node can proceed.

The process 600 proceeds to block 680, where at least some of the nodes displayed at block 660 are associated with a resource, which is represented as a uniform resource locator (URL). The resource can be, for example, an entity that provides one or more technologies or services that can be used in furtherance of a goal, and the URL can be for a website of the entity or a web service provided by the entity. When the URL is selected, the resource can be accessed, such as by displaying the website or accessing the web service. Additionally or alternatively, the URL can link to a website, database, or system where additional information can be accessed, such as implementation details for a technology. In some implementations, a node can be associated with a resource based on a user input. For example, a user can provide an input of the URL representing the resource via a GUI (e.g., GUI 500). In some implementations, the node can be associated with the resource using a parser that identifies that the resource is present in another system (e.g., a system that assesses entity performance). In these and other implementations, when a URL for the resource is selected, an entry for the resource in the other system can be accessed, which can include entity performance information or other entity information. In some implementations, a node can be associated with a resource automatically (e.g., based on keywords in a title or description of a node, based on a node status or category, or the like).

The process 600 proceeds to block 690, where the plan is generated using the goals, nodes, statuses, and resources. Generating the plan can include, for example, generating a graphical representation of the plan for display in a GUI (e.g., GUI 400). Additionally or alternatively, the plan can be represented as a table, a spreadsheet, a delimited file, or another data structure.

In some implementations, the process 600 includes receiving category information for at least some of the nodes. The category information can be received, for example, as a user input, such as a selection from a dropdown menu indicating a category for the node. The category information can be received via a GUI (e.g., the GUI 500) presented at a user device (e.g., of user devices 106a-106n). Categories can relate to, for example, entities associated with the node or categories of products or services associated with the node.

In some implementations, the process 600 includes receiving a note or description for at least some of the nodes. The note or description can be received as a user input, such as a typed user input describing the node and/or characteristics of the node. The note or description can be received via a GUI (e.g., the GUI 500) presented at a user device (e.g., of user devices 106a-106n).

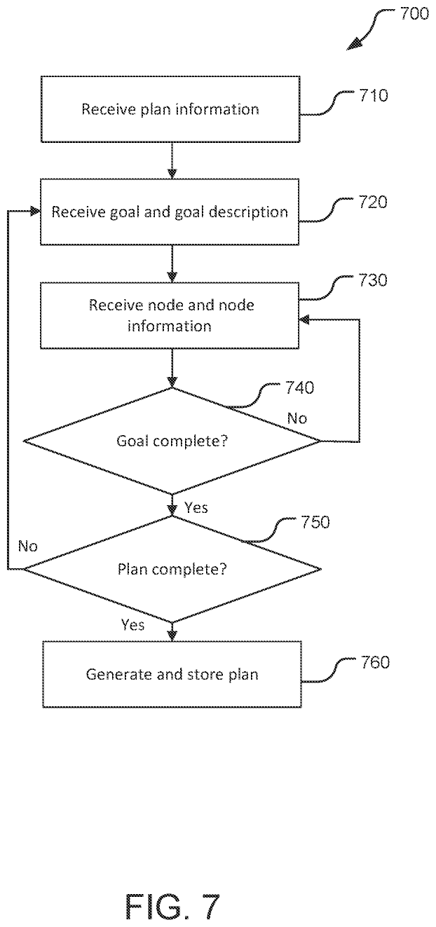

FIG. 7 is a flow diagram illustrating a process 700 performed by a plan generation system (e.g., plan generation system 110 of FIG. 1) to generate a plan based on a set of goals, in some implementations. The process 700 can be performed, for example, using the computing device 200 of FIG. 2. Additionally, the process 700 can be performed using one or more of GUIs 300 of FIG. 3, 400 of FIG. 4, or 500 of FIG. 5.

The process 700 begins at block 710, where plan information is received. The plan information can include, for example, a name, a title, an identifying number, a plan description, a plan type, a plan owner, sharing information, tags, partner entity information, and so forth. The plan information can be received, for example, as a user input and/or determined or retrieved automatically (e.g., from a database and/or as a default input). The plan information can be received via a GUI (e.g., the GUI 300) presented at a user device (e.g., of user devices 106a-106n).

The process 700 proceeds to block 720, where a goal and a goal description are received. As described herein, the goal is a component of the plan. The goal and goal description can be received, for example, as user inputs. In some implementations, one or more goals can be added automatically by the plan generation system, such as based on a plan type. In other words, certain plan types can have one or more goals that are automatically included in the corresponding plan. The goal and goal description can be received via a GUI (e.g., the GUI 400) presented at a user device (e.g., of user devices 106a-106n).

The process proceeds to block 730, where an indication of a node is received, and node information is received for the node. The node can be an action and/or an area of interest associated with the goal. The node information can include a name and/or title, a description or note, a status, a category, and/or a resource. The node information can be received as a user inputs and/or automatically determined or retrieved. Similar to the goal information received at block 720, at least some of the node information can be determined automatically by the plan generation system based on a plan type and/or the goal information. The indication and the node information can be received via a GUI (e.g., the GUI 400) presented at a user device (e.g., of user devices 106a-106n).

The process 700 proceeds to decision block 740, where the plan generation system determines whether the goal is complete. For example, an input can be received (e.g., via the GUI 400) to indicate that a goal is complete, and/or it can be detected that a user has navigated away from the goal and/or navigated to a different goal.

If it is determined at decision block 740 that the goal is not complete, then the process proceeds to block 730 to receive an indication of another node and corresponding node information.

If it is determined at block 740 that the goal is complete, then the process 700 proceeds to decision block 750, where the plan generation system determines whether the plan is complete. For example, an input can be received (e.g., via the GUI 400), such as an input to save and/or generate a plan, which indicates that the plan is complete. Alternatively, if the input is not received, then it will be determined at decision block 750 that the plan is not complete. Additionally or alternatively, an input can be received (e.g., via the GUI 400) to add another goal to the plan, which indicates that the plan is not complete.

If the plan is determined to be complete at decision block 750, then the process 700 proceeds to block 760, where the plan is generated and stored. Generating the plan can include, for example, generating a graphical representation of the plan for display (e.g., in the GUI 400). Additionally or alternatively, the plan can be represented as a table, a spreadsheet, a delimited file, or another data structure.

If it is determined at decision block 750 that the plan is not complete, then the process 700 proceeds to block 720, where an indication of another goal and another goal description are received.

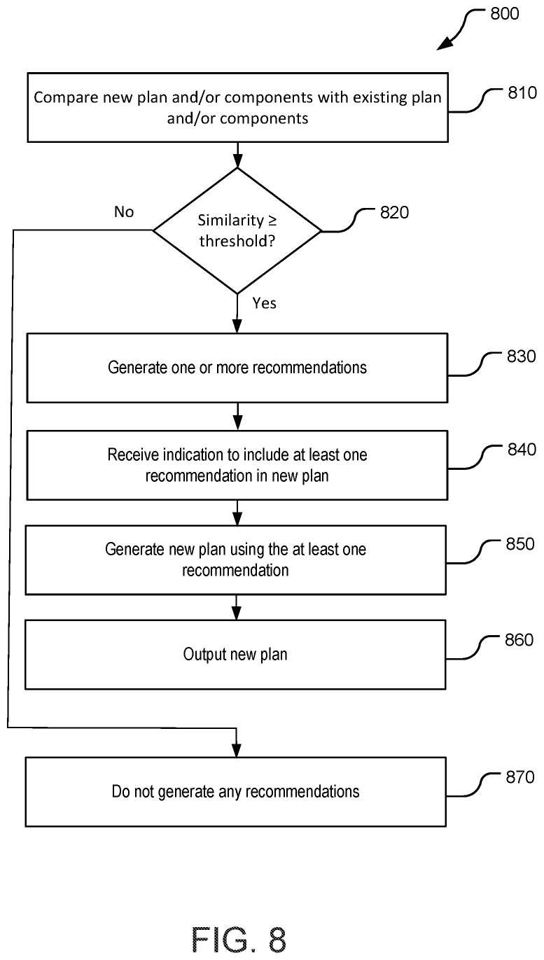

FIG. 8 is a flow diagram illustrating a process to generate recommendations, in some implementations. The process 800 can be performed, for example, using the computing device 200 of FIG. 2. Additionally, the process 800 can be performed using one or more of GUIs 300 of FIG. 3, 400 of FIG. 4, or 500 of FIG. 5. The process begins at block 810, where a new plan and/or one or more components of the new plan are compared with one or more existing plans and/or one or more components in the one or more existing plans. For example, the one or more components of a plan can include a plan type, a summary, a tag, a track, a node, a category, an entity, or combinations thereof. For example, the plan generation system can identify an existing plan that is similar to a new plan being generated, such as based on calculating a similarity score representing a similarity of the existing plan and the new plan. The similarity can be based on similar entities associated with the existing plan and the new plan, similar industries associated with the respective entities, similar goals included in a plan, similar nodes included in a plan, or the like.

The process proceeds to decision block 820, where the plan generation system determines whether a similarity score is equal to or greater than a threshold. Based on a determination that that the similarity score is equal to or greater than the threshold, the process proceeds to block 830, where the plan generation system generates one or more recommendations for the new plan. For example, if the new plan is determined to be similar to the existing plan beyond the threshold, the plan generation system can recommend one or more components of the existing plan to be included in the new plan (e.g., goals, nodes, node characteristics). Additionally or alternatively, the plan generation system can determine that the same or similar goals or nodes present in the existing plan are present in the new plan, and the plan generation system can recommend components of the existing plan to include in the new plan.

The process proceeds to block 840, where the plan generation system receives an indication to include at least one recommendation in the new plan. For example, the one or more buttons 370 in the GUI 300 (FIG. 3) can include a select button and/or an accept button to accept a recommendation and a reject button to not accept a recommendation.

The process proceeds to block 850, where the plan generation system generates the new plan using the at least one recommendation that was indicated in block 840. The new plan is then output at block 860. Non-limiting nonexclusive examples for outputting the new plan include displaying the new plan, printing the new plan, storing the new plan in a storage device, and/or transmitting the new plan to another computing device.

Returning to block 820, based on a determination that the similarity score is below the threshold, the process proceeds to block 870 where the plan generation system does not generate any recommendations for the new plan.

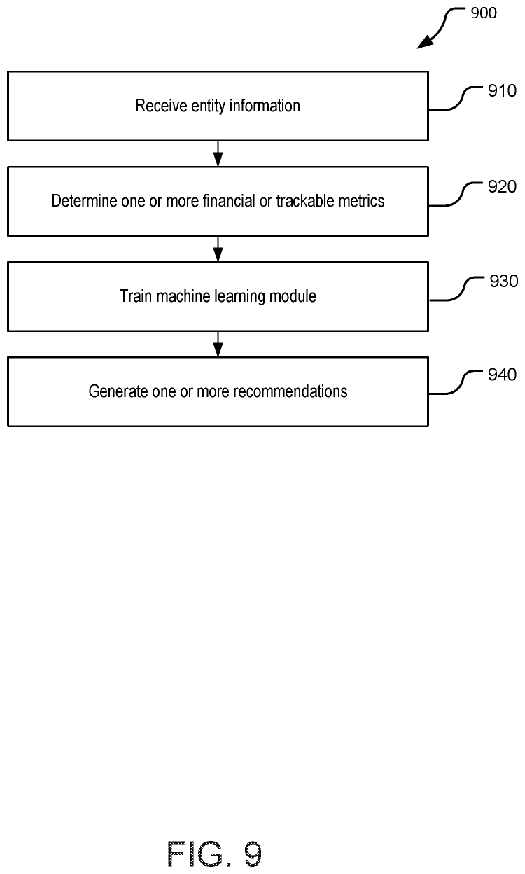

In some implementations, the plan generation system can generate a recommended plan for an entity associated with the plan and based on entity characteristics, such as entity financial information, entity type, entity technology information, or other characteristics. For example, the entity characteristics can be received using the user GUI 300 of FIG. 3. In these and other implementations, the recommended plan can be generated using a machine learning model. The machine learning model can be trained using a training dataset. FIG. 9 is a flow diagram illustrating a process train a machine learning module to generate recommendations, in some implementations. The process 900 can be performed, for example, using the computing device 200 of FIG. 2. The process begins at block 910, where entity information is received. For example, the plan generation system can receive entity information for multiple entities, the entity information including entity types, respective entity financial information, and entity plans.

Using the entity information, the plan generation system determines one or more financial metrics or trackable metrics characterizing the entities at block 920. A training dataset includes the one or more financial metrics or trackable metrics and at least some of the entity information. For example, the training dataset can include a correlation between the financial metrics and the entity type, the entity technology information, and/or a characteristic of an entity plan.

The process proceeds to block 930, where a machine learning model is trained using the training dataset. The training enables the machine learning model to generate recommended plans for entities based on entity types and entity financial information. In these and other implementations, the machine learning model can additionally or alternatively be trained and/or used to generate recommendations of tracks, goals, nodes, resources, and/or associated data for inclusion in a plan. In some implementations, the system can automatically generate prompts (e.g., via a GUI) of recommendations generated using a machine learning model. In some implementations, one or more machine learning models can include and/or use natural language processing models.

The process proceeds to block 940, where one or more recommendations are generated. In some implementations, the plan generation system recommends an entity (e.g., a startup company) as a resource for inclusion in a plan, such as based on determining that the entity is associated with an area of interest or capable of performing an action. The recommendation of the entity can further be based, at least in part, on an estimated performance of the recommended entity. In some implementations, the different entity is identified using the machine learning model.

In some implementations, the plan generation system identifies a recurring resource that is present in a new plan. In other words, the recurring resource already exists in a previous plan. Thus, the plan generation system can identify the recurring resource, which enables the recurring resource from the previous plan to be reused in the new plan (e.g., rather than building or acquiring the recurring resource again). The recurring resource can be, for example, one or more software modules (e.g., applications or code), web services, hardware technologies, software licenses, or the like. Upon identifying the recurring resource, the plan generation system generates a prompt (e.g., a notification, a graphical indicator, a pop window, or the like) to indicate to a user that the resource already exists. In this way, the plan generation system conserves technical resources by preventing the acquisition or development of duplicative or redundant resources for a plan.

Although the processes 600, 700, 800, and 900 shown in FIGS. 6-9, respectively, are illustrated as including particular operations performed in a depicted order, more or fewer operations can be included, and the operations can be performed in any order, including performing one or more operations in parallel.

Unlike existing systems, the plan generation system generates dynamic plans, which can be updated automatically upon the introduction of new or changed information. For example, the processes 600, 700, 800, and/or 900 shown in FIGS. 6-9, respectively, can include defining relationships between various objects, such as plans, tracks, nodes, and/or associated data. After the plan has been generated, the plan generation system can determine whether new or changed information is received associated with the various objects. If new or changed information is detected, then the plan generation system can update the plan, such as by changing other objects based on a change in a plan, track, node, or associated data and based on relations between objects.

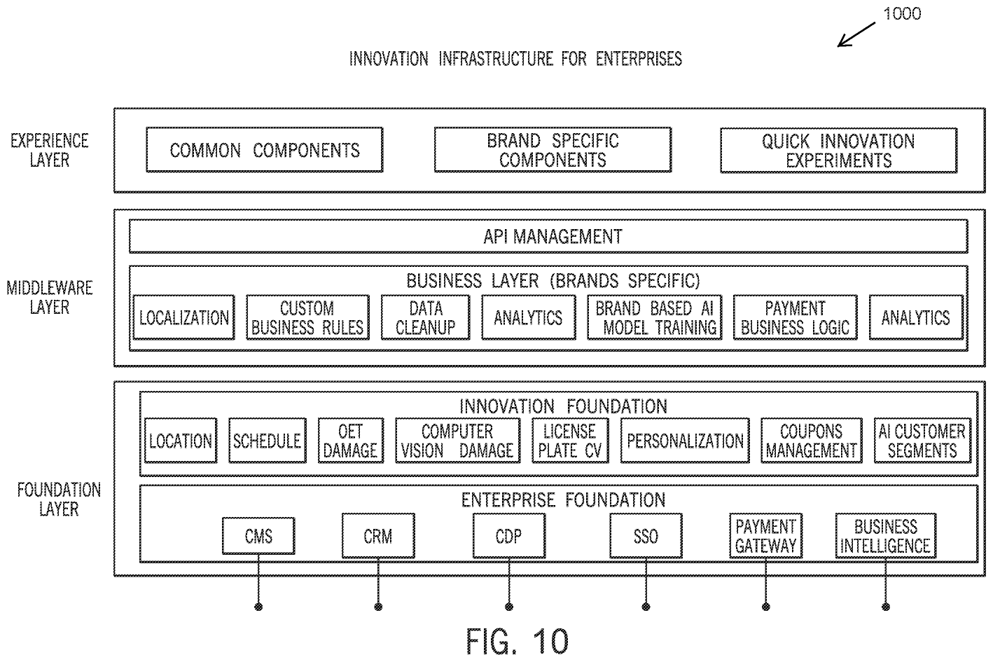

FIG. 10 is a block diagram 1000 illustrating components associated with a plan, in some implementations. For example, the components illustrated in the diagram 1000 can be tracks or nodes included in a plan. The plan can include a track for an experience layer, which can be a track representing user interactions with a product or service (e.g., a software service). The experience layer track includes a common components node, a brand-specific components node, and a quick innovation experiments node. For example, the common components node can include or represent portions of a customer experience that use off-the-shelf technologies or solutions, while the brand-specific components node can include or represent portions of a customer experience that are customized or specific to a brand, company, or service that provides the customer experience. The quick innovations experiments node can include or represent experimental technologies or solutions included in a customer experience on an experimental or trial basis.

The middleware layer track can include an API management node and a business layer node (e.g., a brand-specific business layer node). The middleware layer track can include or represent middleware solutions or technologies used to provide the customer experience represented in the experience layer. For example, the API management node can include or represent various application programming interfaces (APIs) used to provide portions of the customer experience. The business layer node includes or links to various solutions or technologies that are used to provide portions of the customer experience, such as localization, custom business rules, data cleanup, analytics (e.g., data analytics or business analytics), artificial intelligence (AI) model training, and/or payment business logic.

The foundation layer track can include an innovation foundation track and an enterprise foundation track, which can include technologies or solutions (e.g., back-end technologies) used to provide foundational aspects to support the middleware layer and the experience layer. The innovation foundation track can include or link to various solutions or technologies, such as location, schedule, OET damage, computer vision damage, license plate CV, personalization, coupons management, and/or AI customer segments. The enterprise foundation track can include or link to various solutions or technologies, such as content management system (CMS), customer relationship management (CRM), customer data platform (CDP), single sign-on (SSO), payment gateway, and/or business intelligence.

Although specific tracks and nodes are discussed in the context of the diagram 1000 of FIG. 10, other tracks and/or nodes can be used. Additionally, any number of tracks or nodes can be included in a plan.

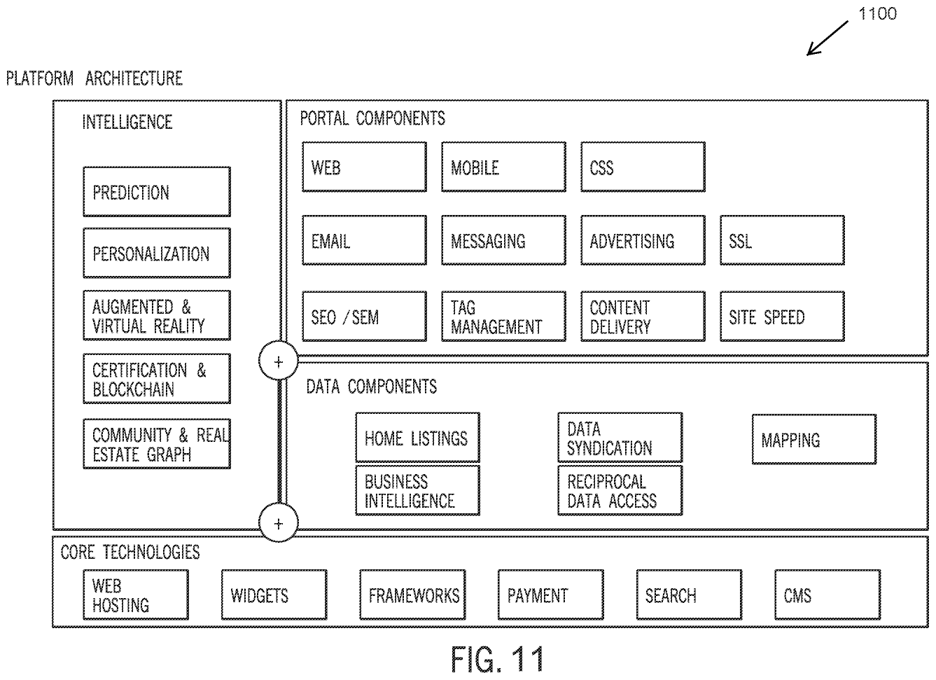

FIG. 11 is a block diagram 1100 illustrating a platform architecture, in some implementations. The platform architecture can be represented as a plan generated using the plan generation system. For example, the plan can be generated and used to implement a platform according to the platform architecture. The platform architecture can be represented using an intelligence track, a portal components track, a data components track, and a core technologies track. The intelligence track can include a prediction node, a personalization node, an augmented & virtual reality node, a certification & block chain node, and/or a community & real estate graph node. The portal components track can include a web node, a mobile node, a cascading style sheets (CSS) node, an email node, a messaging node, an advertising node, a secure sockets layer (SSL) node, a search engine optimization (SEO)/search engine marketing (SEM) node, a tag management node, a content delivery node, and/or a site speed node. The data components track can include a home listings node, a data syndication node, a business intelligence node, a reciprocal data access node, and/or a mapping node. The core technologies track can include a web hostings node, a widgets node, a frameworks node, a payment node, a search node, and/or a CMS node.

Although specific tracks and nodes are discussed in the context of the diagram 1100 of FIG. 11, other tracks and/or nodes can be used. Additionally, any number of tracks or nodes can be included in a plan.

The diagrams 1000 and 1100 can each represent plans generated using the plan generation system, such as plans generated using the GUIs 300, 400, and/or 500 shown in FIGS. 3-5, respectively, and/or the processes 600, 700, 800, and/or 900 shown in FIGS. 6-9, respectively.

The methods and systems are described herein with reference to companies. However, these techniques are equally applicable to other types of entities. Further, while several examples of uses of a system of the present disclosure are described, other uses are contemplated, e.g., in situations where an entity wishes to generate a plan. As such, the discussion of any particular embodiment is meant as illustrative only. Further, features and modules from various embodiments can be substituted freely between other embodiments.

In methodologies directly or indirectly set forth herein, various steps and operations are described in one possible order of operation but those skilled in the art will recognize the steps and operation can be rearranged, replaced, or eliminated without departing from the spirit and scope of the present technology. It is intended that all matter contained in the above description or shown in the accompanying drawings shall be interpreted as illustrative only and not limiting. Changes in detail or structure can be made without departing from the spirit of the technology as defined in the appended claims.

What is claimed is:

1. A computer-implemented method for providing a plan, the method comprising:
displaying, in a user interface, a track that represents a goal;
displaying, in the user interface and within the track, a node that represents a desired action or an area of interest associated with the track;
displaying, in the user interface with the node, a status of the node; and
displaying, in the user interface with the node, a resource associated with the node.

2. The computer-implemented method of claim 1, wherein:
the user interface is a first user interface; and
the computer-implemented method further comprises at least one of:
receiving, via a second user interface, an identifier for the plan; or
receiving, via the second user interface, a type for the plan.

3. The computer-implemented method of claim 1, further comprising receiving, via the user interface, an indication to add the node to the track prior to displaying the node.

4. The computer-implemented method of claim 1, further comprising receiving, via the user interface, an indication to add the goal to the plan prior to displaying the track that represents the goal.

5. The computer-implemented method of claim 1, wherein:
the user interface is a first user interface; and
the computer-implemented method further comprises:
receiving, via a second user interface, entity characteristics of an entity associated with the plan, the entity characteristics including an entity type and entity financial information; and
generating a recommendation for the plan based on the entity type and the entity financial information.

6. The computer-implemented method of claim 5, wherein:
generating the recommendation comprises generating the recommendation using a machine learning model; and
the computer-implemented method further comprises:
receiving entity data for multiple entities, the entity data including, for each entity, the entity type, the entity financial information, and an entity plan;
determining a financial metric or a trackable metric for each entity of the multiple entities;
generating, using the entity data and the financial metric or the trackable metric for each entity of the multiple entities, a training dataset; and
training, using the training dataset, the machine learning model to generate recommendations for entities based on entity types and entity financial information.

7. The computer-implemented method of claim 5, wherein:
the machine learning model includes a natural language processing model; and
the computer-implemented method further comprises automatically generating a prompt to suggest a track or a node to include in the plan.

8. The computer-implemented method of claim 1, further comprising associating the node with the resource prior to displaying the resource, wherein:
the resource is represented in the user interface by an icon; and
the icon is associated with a uniform resource locator.

9. The computer-implemented method of claim 8, wherein the resource includes a different entity, the method further comprising:
identifying the different entity based on determining that the different entity is capable of performing the desired action or that the different entity is associated with the area of interest; and
recommending the identified different entity for inclusion in the plan.

10. The computer-implemented method of claim 9, wherein the recommending of the identified different entity is based on an estimate of a performance of the entity.

11. The computer-implemented method of claim 1, wherein:
the user interface is a first user interface; and
the computer-implemented method further comprises at least one of:
receiving, via a second user interface, a tag for the plan;
receiving, via the second user interface, a name for the plan; or
receiving, via the second user interface, a summary of the plan.

12. A system, comprising:
a processing element; and
a memory component storing instructions, that when executed by the processing element, cause operations to be performed, the operations comprising:
receiving, via a first user interface, an indication to add a goal to a plan;
receiving, via the first user interface, data describing the plan;
displaying, in a second user interface, a track that represents the goal;
receiving, via the second user interface, an indication to add a node to the track, the node representing a desired action or an area of interest associated with the track;
receiving, via a third user interface, data describing the node;
displaying, in the second user interface and within the track, the node; and
displaying, in the second user interface within the node, one or more icons that represent at least one of:
a status of the node;
a resource is associated with the node; or
a category is associated with the node.

13. The system of claim 12, wherein the data describing the plan comprises at least one of:
a plan identifier;
a plan type;
a plan name;
a summary of the plan;
a tag; or
a partner entity associated with the plan.

14. The system of claim 12, wherein the data describing the node comprises at least one of:
the status of the node;
the category associated with the node;
a title;
a description; or
the resource associated with the node.

15. The system of claim 12, wherein the memory component stores further instructions for generating a recommendation for the plan based on an existing plan.

16. The system of claim 15, wherein the further instructions for generating the recommendation for the plan comprises a machine learning model.

17. A method, comprising:
receiving an indication to add a goal to a plan;
receiving data describing the goal;
associating the data describing the goal with a track;
receiving an indication to add a node within the track, the node representing a desired action or an area of interest associated with the goal;
receiving data describing the node;
generating the plan based on the goal, the data describing the plan, and the data describing the node; and
outputting the plan.

18. The method of claim 17, wherein:
the data describing the plan comprises at least one of:
a plan identifier;
a plan type;
a plan name;
a summary of the plan;
a tag; or
a partner entity associated with the plan; and
the data describing the node comprises at least one of:
the status of the node;
the category associated with the node;
a title;
a description; or
the resource associated with the node.

19. The method of claim 17, wherein:
outputting the plan comprises displaying, in a user interface, the plan, the displaying comprising:
displaying, in the user interface, the track; and
displaying, in the user interface, the node within the track.

20. The method of claim 17, further comprising generating a recommended plan for the plan prior to associating the data describing the plan with a track, the recommended plan generated by a machine learning model.
